(19) United States
(12) Patent Application Publication
(10) Pub. No.: US 2006/0150194 A1
(43) Pub. Date: Jul. 6, 2006

(54) Methods and apparatuses to maintain multiple execution contexts

(76) Inventors: Bin Xing, Changning District (CN); Yi Chen, Puruo District (CN)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/218,418

(22) Filed: Sep. 1, 2005

(30) Foreign Application Priority Data
Dec. 30, 2004 (WO) PCT/CN04/01572

(51) Int. Cl. G06F 9/46

(52) U.S. Cl. 718/108

(57) ABSTRACT

A method, apparatus, and system in which a two or more execution contexts of threads are maintained simultaneously using stack switching in an operating environment in which merely one thread can be executed at a given point in time. Execution of instructions in a callee thread is suspended and the execution context including a return address location of a pointer of the callee stack is maintained while instructions are being executed in a caller thread.

### RELATED APPLICATIONS

This application claims priority to and the benefit of PCT application no. PCT/CN2004/001572, entitled “METHODS AND APPARATUSES TO MAINTAIN MULTIPLE EXECUTION CONTEXTS”, filed on Dec. 30, 2004. This application hereby incorporates the contents of the PCT application by reference.

### FIELD

Aspects of embodiments of the invention relate to the field of executing instructions associated with two or more threads. More specifically, aspects of embodiments of the invention relate to the maintaining of the execution context associated with those threads.

### BACKGROUND

In a single-tasking operating system, typically one thread is allowed to be executed at a time in a single-tasking operating environment.

FIG. 1 illustrates how a traditional function call works in a single tasking operating environment. The system includes a caller function, a callee function, and a common stack associated with datum such as data and parameters from both the callee function and the caller function. Adding items such as data, parameters, etc into a stack is known as pushing. Removing items from the stack is known as popping. The application executes instructions. The common stack maintains the datum associated with the executed instructions. One of the instructions may be a function call. In a traditional function call, the caller function will pass the control to the callee function at the end of phrase 1 when calling the callee function. The callee function puts its execution context on to the stack. The execution context of the callee function is placed on top of the caller functions execution context. The caller function regains the control back when the callee function finishes all of the instructions associated with that function, indicated as phase 2 in FIG. 1. The callee function is responsible for returning control to the caller function after the callee function has finished processing all of its instructions. At phase 3, the caller function then resumes execution of the instructions associated with the caller function and finishes the remaining instructions associated with the caller function.

FIG. 1 also shows the execution context in the stack change during different phases. The system maintains one set of execution context for the common stack. The caller function and callee function can share a common stack to keep their stack frames. At phase 2, instructions are executed in the callee function. The execution context of the callee function is piled on top of the execution context of the caller function in the common stack. The single stack pointer associated with the common stack generally points to the items being put on top of the stack. The callee function effectively blocks its caller function in the traditional function call until the callee function executes all of its instructions.

### BRIEF DESCRIPTION OF THE DRAWINGS

The drawings refer to embodiments of the invention in which:

FIG. 1 illustrates how a traditional function call works in a single tasking operating environment.

FIG. 2 illustrates a diagram of an embodiment of a multiple execution context routine running in an operating environment where merely one thread can be executed at any given point in time.

FIGS. 3a and 3b illustrate a flow diagram of an embodiment of a multiple execution context routine to allow two or more threads to operate simultaneously in an operating environment in which merely one thread can be executed at a given point in time.

FIG. 4 illustrates a block diagram of an example computer system that may use an embodiment of the routine to maintaining two or more execution contexts of threads simultaneously using stack switching.

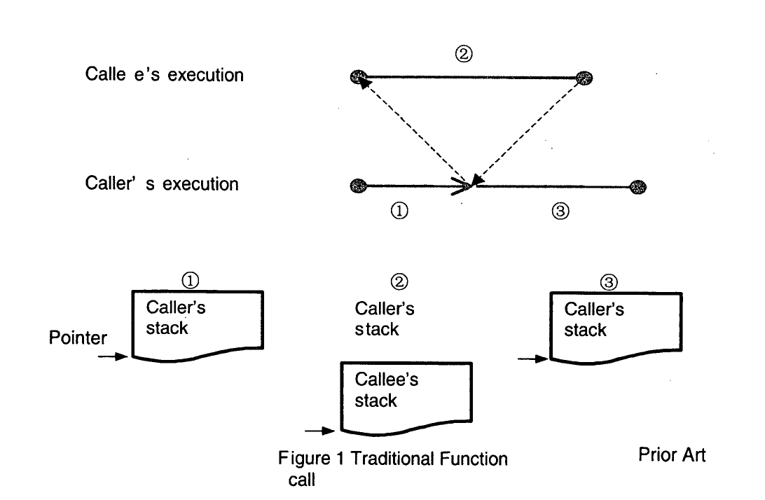

While the invention is subject to various modifications and alternative forms, specific embodiments thereof have been shown by way of example in the drawings and will herein be described in detail. The embodiments of the invention should be understood to not be limited to the particular forms disclosed, but on the contrary, the intention is to cover all modifications, equivalents, and alternatives falling within the spirit and scope of the invention.

### DETAILED DISCUSSION

In the following description, numerous specific details are set forth, such as examples of specific functions, named components, etc., in order to provide a thorough understanding of the embodiments of the invention. It will be apparent, however, to one of ordinary skill in the art that the embodiments of the invention may be practiced without these specific details. Further, the specific numeric reference should not be interpreted as a literal sequential order but rather interpreted that the first thread is different than a second thread. Thus, the specific details set forth are merely exemplary. The specific details may be varied from and still be contemplated to be within the spirit and scope of the present invention.

In general, various methods and apparatus are described that implement a multiple execution context routine. The multiple execution context routine may maintain two or more execution contexts of threads simultaneously using stack switching in an execution environment in which merely one thread can be executed at a given point in time. A callee thread may explicitly suspend execution of its instructions. The multiple execution context routine still maintains the execution context including a return address location of a pointer of the callee stack while instructions are being executed in a caller thread.

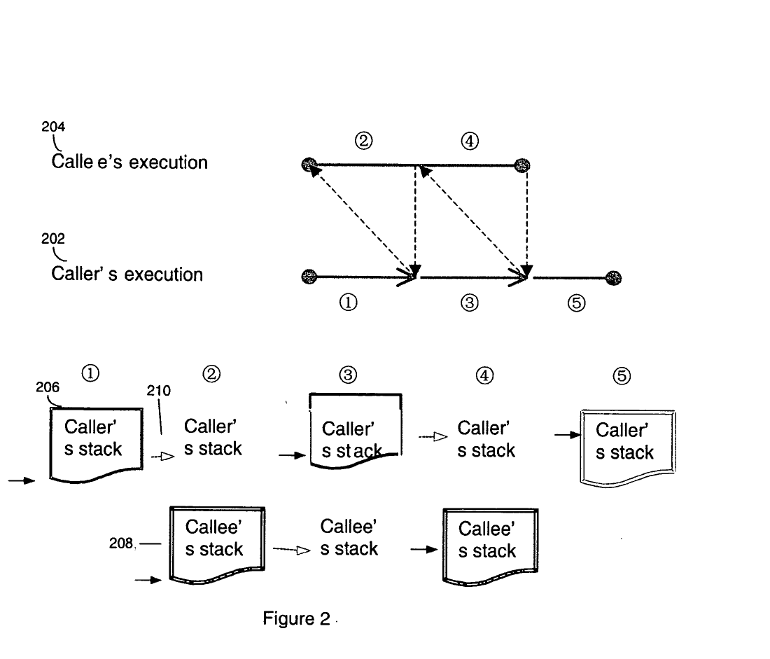

FIG. 2 illustrates a diagram of an embodiment of a multiple execution context routine running in an operating environment where merely one thread can be executed at any given point in time. The system includes a caller thread 202, a callee thread 204, and a first memory area dedicated to store a first execution context of the caller thread 202, a second memory area dedicated to store a first execution context of the callee thread 204. The first memory area is the caller stack 206. The second memory area is the callee stack 208.

The callee thread 204 and caller thread 202 may utilize a routine implemented in software, embedded in firmware, implemented in logic of a finite state machine, or other similar mechanism. Note, the routine implemented in software will be used in the following description to assist in the understanding of the routine. The routine maintains two or more execution contexts of threads simultaneously using stack switching in an operating environment in which merely one thread can be executed at a given point in time. A callee thread 204 may explicitly suspend execution of its instructions. The multiple execution context routine still maintains the execution context including a return address location of a pointer of the callee stack 208 while instructions are being executed in a caller thread 202. Similarily, a caller thread 202 may explicitly suspend execution of its instructions. The multiple execution context routine still maintains the execution context including a return address location of a pointer of the caller stack 206 while instructions are being executed in a callee thread 204.

A thread may be a sequence of instructions executed in sequential order to accomplish a task or at least a specific aspect of a task by a CPU (Central Processing Unit), ASIC (Application Specific Integrated Circuit), or similar processing device. Two or more threads may collaborate to accomplish a single task. The independency of tasks and independency of completing separate aspects of a task is what matters in a multi-tasking operating system.

Thus, the caller thread 202 and the callee thread 204 may collaborate on a single task but are responsible for different parts of that task. The caller thread 202 and the callee thread 204 may also be carrying out separate tasks. The thread that initiates a call suspends execution of its instructions whenever that thread initiates the call to the other thread.

The routine allocates the first memory area to be the caller stack 206 for the caller thread 202. The routine stores the first execution context of the caller thread 202 in the caller stack 206 as the instructions in the caller thread 202 are executed. The stored execution context of the caller thread may contain datum, such as caller's local data, parameters need to pass into the callee, and return address of the pointer associated with the caller stack 206. The application software may use the pointer when executing instructions with the caller thread 202. The instructions in the caller thread 202 may reach a point, where the caller thread 202 wishes to suspend and explicitly gives up execution of instructions. The caller thread 202 may wish to communicate with another thread, or caller thread 202 knows its will be idle for a substantial period in time waiting on a response to request with a long response time, etc. The caller thread 202 suspends and explicitly gives up execution of instructions in the caller stack 206 when the caller thread 202 calls to a callee thread 204. The routine then stores an execution context of the caller thread 202 including a current address of the pointer in the caller stack 206.

At time 2, the routine allocates the second memory area to be the callee stack 208 for the callee thread 204. The routine stores the second execution context of the callee thread 204 in the callee stack 208 as the instructions in the callee thread 204 are executed. The stored execution context of the callee thread may contain datum, such as callee's local data, parameters need to pass into the caller, and return address of the pointer associated with the caller stack 206. The application software may use the pointer on the caller's execution context when executing instructions with the callee thread 204.

At this point in time, the routine maintains the execution contexts of both the callee thread 204 and the caller thread 202 including the address of the pointers on both stacks simultaneously in an operating environment in which merely one thread can be executed at a given point in time. The address of the pointer 210 on the inactive caller stack 206 is stored while the application software uses the location of the pointer on the active callee stack 208. A hardware register may be used to store the address location of the pointer for the current active stack.

Thus, the routine directs the application software to the current stored execution context when a stack switch occurs. The application queries the hardware register to determine where the pointer is located on the stack. The routine controls what address is stored in that hardware register.

The routine allows multiple tasks as well as multiple aspects of a single task to be run contemporaneously in a single tasking operating environment. However, at any given moment in time, merely one stack is actively being manipulated as instructions in the thread are being executed and the other stack is simply maintaining a stored execution context associated with the other thread. Further, the storing of execution context in the callee stack associated with the callee thread is autonomous from the storing of execution context in the caller stack associated with a caller thread because the execution contexts are maintained in separate memory areas. The two or more execution contexts being maintained in separate memory areas eliminates the execution contexts being stack on top of each other and automatically changing the location of the pointer.

A stack may be a set of hardware registers or a reserved amount of memory used to keep track of internal operations. Stacks are generally operate in a Last In First Out (LIFO) basis causing the last set of datum pushed onto the stack to be the first set of datum to be popped from the stack.

The callee thread 204 may reach a point in the execution of instructions where the callee thread 204 wishes to communicate with another thread, or some other reason to give up executing its instructions. At time 3, the routine restores the stored execution context and the pointer location on the caller stack 206 when the callee thread 204 suspends execution of its instructions. The routine restores the stored execution context by switching the application software over to the other threads instructions and stored context. The routine changes the address of the pointer stored in the hardware register over to the caller thread's pointer address. The caller thread 202 begins executing instructions from address where the pointer left off when the caller thread 202 explicitly suspended its execution of instructions.

The routine allows the suspension of executing instructions and execution context stack switching between the threads until all of the threads have completed executing all of the instructions associated with those threads. Moreover, the routine restores the stored execution context of the caller thread 202 and the pointer location on the caller stack 206 prior to the completion of all of the instructions associated with the callee thread 204. The routine restores the stored execution context of the caller thread 202 and the pointer location on the caller stack 206 when the callee thread explicitly gives control back over to the caller thread 202.

The callee thread 204 and the caller thread 202 may use the suspension of executing instructions and stack switching to synchronize when collaborating on completing the different parts of the single task. Each thread can be started or shut down independently of the completion of other threads in this single tasking environment. Each thread executes instructions as if that thread is the only thread being executed in the system, except that the thread from time to time uses a function call to explicitly give up control and execution of instructions. The routine allows all the threads to run contemporaneously without interfering with each other's instruction execution order or execution context associated with those instructions.

The routine maintains multiple execution contexts using stack switching, which enables multiple threads to be maintained simultaneously in a single-threaded environment.

Overall, the callee thread 204 can suspend itself explicitly at some point and then be resumed by the caller thread 202 later. An additional stack is dedicated to store the execution context of each new callee thread 204 to avoid interference between the threads. Similarly, the caller thread 202 can suspend itself explicitly at some point and then be resumed by the callee thread 204 later.

The following is some pseudo code to implement the stack switching function of the routine.

```
typedef struct_EXEC_CTX {
  jmp_buf *retCtx;
  jmp_buf threadCtx;
  unsigned long *stack;
} EXEC_CTX;
// ExecCtx is a pointer to an EXEC_CTX structure
// EntryPoint is a pointer to the thread entry function (corresponding to MAIN function in
the pseudo code below)
// Arg is the argument passed to EntryPoint (corresponding to Command function in the
pseudo code below)
Function StartExecCtx(ExecCtx, EntryPoint, Arg) {
  SuspendExecCtx(ExecCtx);
  (*EntryPoint)(Arg);
```

| | |
|---|---|
| longjmp(Exec->retCtx, 2); | // Return to scheduler |

}
Function InitExecCtx(ExecCtx, EntryPoint, Arg) {
jmp_buf thisCtx;

| ExecCtx->stack = malloc(STACK_SIZE); | | // Allocate a stack for the thread |
|---|---|---|
| ExecCtx->retCtx = &thisCtx; | | |
| if (!setjmp(ExecCtx->retCtx)) { | | |
| | _{——}asm mov esp, stack + STACK_SIZE; | // Here we switch to the new stack |

StartExecCtx(ExecCtx, EntryPoint, Arg);

```
  }
}
Function RunExecCtx(ExecCtx) {
  jmp_buf thisCtx;
  ExecCtx->retCtx = &thisCtx;
  switch (setjmp(ExecCtx->retCtx)) {
  case 0:
```

| | |
|---|---|
| longjmp(&ExecCtx->threadCtx, 1); | // Switch to thread |

case 1:

| | |
|---|---|
| return false; | // EntryPoint not finished yet |

case 2:

| | |
|---|---|
| return ture; | // EntryPoint finished |

```
  }
}
Function ReleaseExecCtx(ExecCtx) {
  free(ExecCtx->stack);
}
Function SuspendExecCtx(ExecCtx) {
  if (!setjmp(&ExecCtx->thread))
```

| | |
|---|---|
| longjmp(ExecCtx->retCtx, 1); | // Switch to scheduler |

}

The setjmp, longjmp, malloc and free are standard C programming language functions provided by most compilers. A function call is statement that attempts to communicate with or requests services from another subroutine, thread, or program. The call is physically made to the thread by a branch instruction or some other linking method that is created by the assembler, compiler or interpreter.

The setjmp( ) function saves its stack environment in an argument for later use by longjmp( ) function. The longjmp( ) function restores the environment saved by the last call of setjmp( ) function with the corresponding argument. After longjmp( ) function completes, program execution continues as if the corresponding call to setjmp( ) function had just returned the value val. At the time of the return from setjmp( ) function, all external and static data variables have values as of the time longjmp( ) function is called. After longjmp( ) function is completed, program execution continues as if the corresponding invocation of setjmp( )function had just returned the value specified by val.

The malloc( ) and free( ) functions provide a simple, general-purpose memory allocation package. The malloc( ) function returns a pointer to a block of memory of at least size bytes suitably aligned for a stack. The argument to free( ) function is a pointer to a block previously allocated by malloc( )function. After free( ) function is executed, this space is made available for further allocation by the thread, though not returned to the system. Memory is returned to the system upon termination of the thread.

The InitExecCtx is an inline assembler function that allows direct manipulation of the stack pointer. The InitExecCtx may be wholly written in assembler to avoid unexpected results. The term ‘thread’ refers to the execution context defined in the pseudo code. The term ‘schedule’ refers to the code that calls the InitExecCtx function and the RunExecCtx function to run the ‘thread’.

The following is an example application of the routine and corresponding pseudo code.

Client Extensible Firmware Interface (EFI) Agent is an EFI application run in the pre-boot phase of the client. What the agent does is receive commands from the Server, and execute the commands one by one. While a command is being executed, the agent should report the progress to the server in a timely manner, or the client will be considered dead.

The agent could be logically divided into 2 or more thread parts, called the ‘core’ and the ‘units’. The core's responsibility is to receive commands from the server, dispatch them to the proper unit, and report the progress of the unit to the server. A ‘unit’ is a group of functions that could accomplish a certain task. To be accurate, each unit provides to the core the following four functions to invoke: ‘support’, ‘init’, ‘exec’ and ‘final’. The pseudo code below shows how the core finds the proper unit and executes the command.

| | |
|---|---|
| Unit = getNextUnit(NULL); | // Get the first registered unit |
| while (Unit != NULL) { | |

if (Unit->Support(Command)) {

| | |
|---|---|
| Unit->Init(Command); | // Proper unit found, invoke Init |

| | |
|---|---|
| while (!Unit->Exec(Command)) | // Invoke Exec for as many times as needed |

ReportCommandProgress(Command);

| | |
|---|---|
| Unit->Final(Command); | // Invoke Final |

| | |
|---|---|
| ReportCommandDone(Command); | // Tell server the command is done |
| break; | |

}
Unit = getNextUnit(Unit);

}

The pseudo code of the unit is as follows.

| | |
|---|---|
| Function Main(Command) { | // What the unit does is placed in this |

| | |
|---|---|
| . . . | // function which produces tangible output |

| | |
|---|---|
| SuspendExecCtx(ExecCtx); | // Explicitly give up execution |

| | |
|---|---|
| . . . | // Continue processing |

| | |
|---|---|
| SuspendExecCtx(ExecCtx); | // Give up execution again |
| . . . | |
| } | |
| Function Init(Command) { | |

| | |
|---|---|
| InitExecCtx(ExecCtx, Main, Command); | // Initialize execution context |
| } | |
| Function Exec(Command) { | |
| return RunExecCtx(ExecCtx); | // Resume execution of Main |
| } | |
| Function Final(Command) { | |

| | |
|---|---|
| ReleaseExecCtx(ExecCtx); | // Cleanup |
| } | |

The SuspendExecCtx, InitExecCtx, RunExecCtx and ReleaseExecCtx functions of the routine achieve independency of tasks. The Function Main implements the logic of the unit. The Function Main could be coded as an ordinary function with some injected calls to the SuspendExecCtx function. Developers can keep the logic, in one piece rather then having to break the logic into multiple pieces. The SuspendExecCtx function appears twice in the Main function for illustration purpose. Actually there's no limitation on where and how many times the SuspendExecCtx function may appear. The SuspendExecCtx function could also appear in functions other than Main function but should be invoked directly or indirectly by the Main function. The InitExecCtx function should be called before any other operations performed on a given execution context object. An execution context object may be suspended by calling the SuspendExecCtx function. The execution context object then is in a suspended state and cannot be suspended again before it is returned to run state. The execution context object may run again by calling the RunExecCtx function. The execution context object in the running state and cannot be run again before it is returned to a suspended state. The stack pseudo code previously listed further elaborates on the implementation details of the SuspendExecCtx, InitExecCtx, RunExecCtx and ReleaseExecCtx functions.

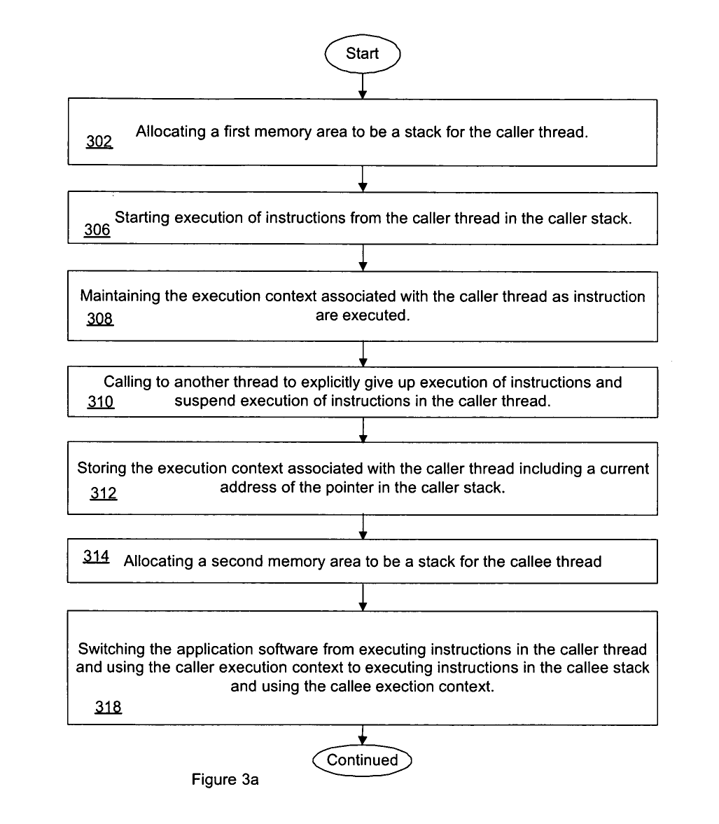

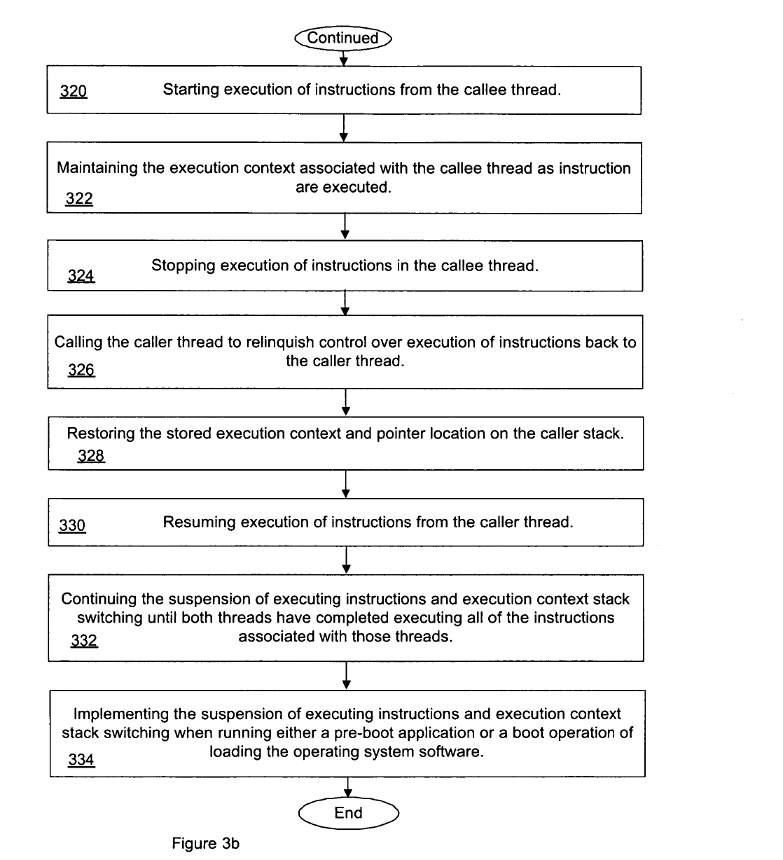

FIGS. 3a and 3b illustrate a flow diagram of an embodiment of a multiple execution context routine to allow two or more threads to operate simultaneously in an operating environment in which merely one thread can be executed at a given point in time.

In block 302, the multiple execution context routine allocates a first memory area to be a stack for the caller thread. The first memory area becoming the stack dedicated to store the execution context of the caller thread, namely the caller stack.

In block 306, the application software starts execution of instructions from the caller thread.

In block 308, the multiple execution context routine maintains the execution context associated with the caller thread as instructions are executed. The stored execution context of the caller thread may contain datum, such as caller's local data, parameters need to pass into the callee, and the current address of the pointer associated with the caller stack.

In block 310, the caller thread calls to another thread, the callee thread, to explicitly give up execution of instructions. The caller thread suspends executing instructions and explicitly gives up instruction execution control. The caller thread and callee thread may collaborate on a single task but are responsible for different parts of that task. The thread that initiates the call suspends execution of its instructions whenever that thread initiates a call to the other thread. The caller thread suspends executing instructions because the caller thread could be waiting for a long response period to a request, waiting to synchronize with other threads, or other similar periods of being idle.

A procedure is a section of a program that performs a specific task. A procedure may be a thread. Thus, procedures collaborating on one task but responsible for different part of that task will suspend themselves whenever they need to communicate with each other, and will give up the system control, and then let the other procedure to continue to run.

In block 312, the multiple execution context routine stores a current address of the pointer in the caller stack along with the execution context associated with the caller thread. The stored execution context includes the return address of the pointer in the caller stack at the point of the switch.

In block 314, the multiple execution context routine allocates a second memory area to be a stack for the callee thread. The second memory area becomes the stack dedicated to store the execution context of the callee thread, the callee stack.

In block 318, the multiple execution context routine switches the application software from executing instructions in the caller thread to executing instructions in the callee thread. The multiple execution context routine also switches the application software over to using the execution context stored in the callee stack.

In block 320, the application software starts execution of instructions from the callee thread.

In block 322, the multiple execution context routine maintains the execution context associated with the callee thread as instruction are executed. Thus, the system maintains two or more execution contexts of threads simultaneously using stack switching in an operating environment in which merely one thread can be executed at a given point in time. The routine suspends execution of instructions associated with a caller thread and still maintains the execution context including a return address location an address of a pointer on of the callee stack while executing instructions associated with a caller thread.

In block 324, the callee thread stops executing instructions by suspending executing instructions from the callee thread or by completing of all of the instructions from the callee thread.

In block 326, the callee thread relinquishes control over execution of instructions back to the caller thread. The callee thread calls the caller thread to relinquish control over execution of instructions back to the caller thread. In some cases, two or more threads are sometimes required to accomplish a single task. Accordingly, now each thread can be started or shut down independently of the completion of instructions associated with the other threads.

In block 328, the multiple execution context routine initializes to restore the stored execution context and pointer location on the caller stack.

In block 330, the multiple execution context routine directs the application software to resume execution of instructions from the caller thread. Thus, multiple tasks can be started or shut down independently off each other; however, the tasks run in the operating environment are run not at the same time as in some multi-tasking operating environments but rather contemporarily during a same period of time. The routine using stack switching may be a solution for tasks requiring concurrency in single threading environment.

In block 332, the multiple execution context routine continues the suspension of executing instructions and execution context stack switching until both threads have completed executing all of the instructions associated with those threads. The application software with the multiple execution contexts routine allows different parts of one or more programs, called threads, to execute contemporaneously. The multiple execution context routine allows the threads to run during the same period of time without substantially interfering with the instruction execution order of each other or execution context of each other.

In block 332, in some embodiments, the multiple execution context routine executes the suspension of executing instructions and stack switching when running either a pre-boot application or a boot operation of loading the operating system software. The multiple execution context routine may be embedded in firmware so that the running of multiple contemporaneously tasks may be utilized when running either a pre-boot application or a boot operation of loading the operating system software.

The multiple execution context routine may be implemented in a single-tasking operating environment, such as boot and pre-boot operating environments, to achieve concurrency and flexibility of tasks as seen in multi-tasking environments. The routine may be stored in foundation code embedded in firmware.

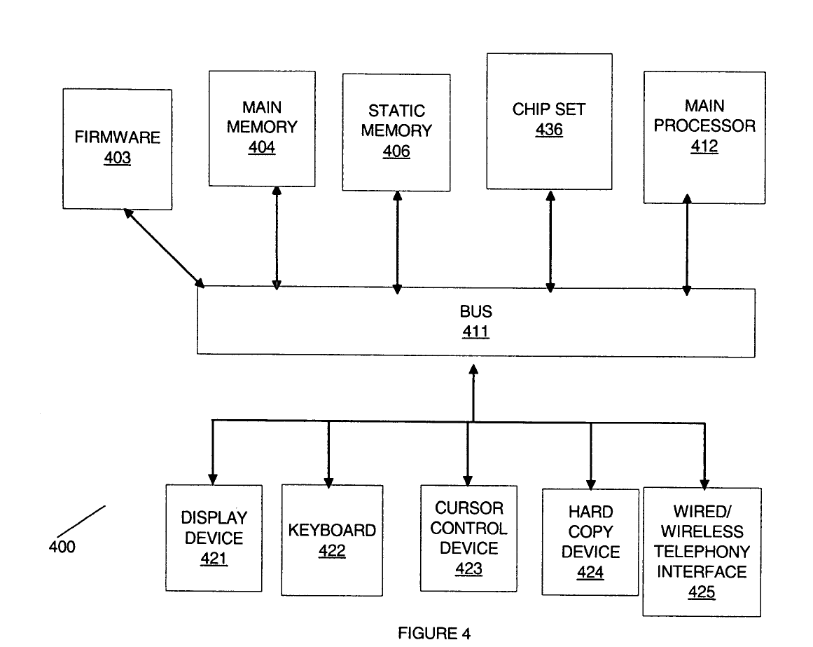

FIG. 4 illustrates a block diagram of an example computer system that may use an embodiment of the routine to maintaining two or more execution contexts of threads simultaneously using stack switching. In one embodiment, computer system 400 comprises a communication mechanism or bus 411 for communicating information, and an integrated circuit component such as a processor 412 coupled with bus 411 for processing information. One or more of the components or devices in the computer system 400 such as the processor 412 or a chip set 436 may use an embodiment of the routine to run multiple contemporaneously tasks.

Computer system 400 further comprises a random access memory (RAM) or other dynamic storage device 404 (referred to as main memory) coupled to bus 411 for storing information and instructions to be executed by processor 412. Main memory 404 also may be used for storing temporary variables or other intermediate information during execution of instructions by processor 412.

Firmware 403 may be a combination of software and hardware, such as Electronically Programmable Read-Only Memory (EPROM) that has the operations for the routine recorded on the EPROM. The firmware 403 may embed foundation code, basic input/output system code (BIOS), or other similar code. The firmware 403 may make it possible for the computer system 400 to boot itself. The starting-up of a computer is called booting, which involves loading the operating system and other basic software. The firmware 403 may be an Extensible Firmware Interface (EFI). The EFI provides boot and runtime service calls that are available to the operating system and its loader. This provides a standard environment for booting an operating system and running pre-boot applications.

Computer system 400 also comprises a read-only memory (ROM) and/or other static storage device 406 coupled to bus 411 for storing static information and instructions for processor 412.

Computer system 400 may further be coupled to a display device 421, such as a cathode ray tube (CRT) or liquid crystal display (LCD), coupled to bus 411 for displaying information to a computer user. An alphanumeric input device (keyboard) 422, including alphanumeric and other keys, may also be coupled to bus 411 for communicating information and command selections to processor 412. An additional user input device is cursor control device 423, such as a mouse, trackball, trackpad, stylus, or cursor direction keys, coupled to bus 411 for communicating direction information and command selections to processor 412, and for controlling cursor movement on a display device 412.

Another device that may be coupled to bus 411 is a hard copy device 424, which may be used for printing instructions, data, or other information on a medium such as paper, film, or similar types of media. Furthermore, a sound recording and playback device, such as a speaker and/or microphone (not shown) may optionally be coupled to bus 411 for audio interfacing with computer system 400. Another device that may be coupled to bus 411 is a wired/wireless communication capability 425.

In one embodiment, the software used to facilitate the routine can be embedded onto a machine-readable medium. A machine-readable medium includes any mechanism that provides (i.e., stores and/or transmits) information in a form accessible by a machine (e.g., a computer, network device, personal digital assistant, manufacturing tool, any device with a set of one or more processors, etc.). For example, a machine-readable medium includes recordable/non-recordable media (e.g., read only memory (ROM) including firmware; random access memory (RAM); magnetic disk storage media; optical storage media; flash memory devices; etc.), as well as electrical, optical, acoustical or other form of propagated signals (e.g., carrier waves, infrared signals, digital signals, etc.); etc.

While some specific embodiments of the invention have been shown the invention is not to be limited to these embodiments. For example, the operations performed with the software code may be comparably duplicated by logic configured to perform those operations in a finite state machine. The example communication thread discussed above in the EFI agent could be implemented as the main thread. The main thread responds to the progress queries issued by the server. Each worker threads takes the internal state as input, does something, updates its internal state and tells the communication thread its progress on output. The communication thread keeps calling the work threads and responds to server queries whenever the function provided by the work thread is returned. All worker threads can share the same communication thread. The work threads and the communication thread can be maintained independently with the routine. The invention is to be understood as not limited by the specific embodiments described herein, but only by scope of the appended claims.

We claim:

1. A method, comprising:
maintaining two or more execution contexts of threads simultaneously using stack switching in an operating environment in which merely one thread can be executed at a given point in time; and
suspending execution of instructions in a callee thread and still maintaining the execution context including a return address location of a pointer of the callee stack while instructions are being executed in a caller thread.

2. The method of claim 1, further comprising:
suspending execution of instructions in the caller thread and giving control over execution of instructions back to the callee thread prior to the caller thread completing execution of all of its instructions.

3. The method of claim 1, wherein the caller thread and the callee thread collaborate on a single task but are responsible for different parts of that task, and the thread that initiates a call suspends execution of its instructions whenever that thread initiates the call to the other thread.

4. A computer readable medium storing instructions to cause a machine to perform the method of claim 1.

5. A finite state machine having logic configured to implement the method of claim 1.

6. The method of claim 1, further comprising:
executing the method in claim 1 when running a pre-boot application.

7. The method of claim 1, further comprising:
executing the method in claim 1 during a boot operation of loading the operating system software.

8. A computer readable medium storing instructions to cause a machine to perform the following operations, comprising:
suspending and explicitly giving up execution of instructions in a first thread when a first thread calls to a second thread; and
storing an execution context of the first thread including data, parameters, and an address of a pointer on the first stack while instructions are being executed in the second thread.

9. The article of manufacture of claim 8, wherein the first thread is a callee thread and the first stack is dedicated to storing the execution context of the callee thread.

10. The article of manufacture of claim 8, wherein the storing and the suspending occur in an operating environment in which merely one thread can be executed at a given point in time.

11. The article of manufacture of claim 8, wherein the computer readable medium stores additional instructions to cause the machine to perform the following operations, comprising:
allocating a first memory area to be a stack for a caller thread, wherein the first memory area is dedicated to store the first execution context of the caller thread; and
allocating a second memory area to be a stack for a callee thread, wherein the second memory area is dedicated to store the second execution context of the callee thread.

12. The article of manufacture of claim 9, wherein the computer readable medium stores additional instructions to cause the machine to perform the following operations, comprising:
maintaining the execution contexts of both the callee thread and the second thread including the address of the pointers on both stacks simultaneously in an operating environment in which merely one thread can be executed at a given point in time.

13. The article of manufacture of claim 9, wherein the computer readable medium stores additional instructions to cause the machine to perform the following operations, comprising:
restoring the stored execution context and the pointer location on the callee stack when the second thread suspends execution of its instructions.

14. The article of manufacture of claim 9, wherein the computer readable medium is firmware.

15. The article of manufacture of claim 9, wherein the computer readable medium stores additional instructions to cause the machine to perform the following operations, comprising:
switching application software from using the execution context in the second stack to using the execution context in the first stack.

16. The article of manufacture of claim 9, wherein the storing of execution context in the first stack associated with the callee thread is autonomous from the storing of execution context in the second stack associated with a caller thread.

17. The article of manufacture of claim 9, wherein the callee thread and the second thread collaborate on a single task but are responsible for different parts of that task.

18. A system, comprising:
a first memory area dedicated to storing a first execution context of a first thread;
a second memory area dedicated to storing a second execution context of a second thread; and
firmware embedded with a routine to direct storing an execution context of the first thread including an address of a pointer on the first memory area, to initiate an execution of instructions in a second thread when the first thread initiates a call to the second thread, and to direct storing an execution context of the second thread including an address of a pointer on the second memory area.

19. The system of claim 18, wherein the firmware embedded with the routine also restores the stored execution context of the first thread and the pointer location on the first memory area prior to the completion of all of the instructions associated with the second thread.

20. The system of claim 18, further comprising:
a processor cooperating with the firmware.
